(19) United States
(12) Patent Application Publication
(10) Pub. No.: US 2023/0408322 A1
(43) Pub. Date: Dec. 21, 2023

(54) WORK MACHINE AND WORK MACHINE SUPPORT SYSTEM

(71) Applicant: SUMITOMO HEAVY INDUSTRIES, LTD., Tokyo (JP)

(72) Inventors: Kazunori HIRANUMA, Kanagawa (JP); Jun NISHIMAKI, Kanagawa (JP)

(21) Appl. No.: 18/461,852

(22) Filed: Sep. 6, 2023

Related U.S. Application Data
(63) Continuation of application No. PCT/JP2022/016334, filed on Mar. 30, 2022.

(30) Foreign Application Priority Data
Mar. 31, 2021 (JP) 2021-060110

(51) Int. Cl. G01G 19/08; G01G 19/14

(52) U.S. Cl. CPC G01G 19/08; G01G 19/14; E02F 9/2285

(57) ABSTRACT

A work machine includes processing circuitry, and a memory storing computer-readable instructions, which when executed by the processing circuitry, cause the work machine to perform a process including calculating a load weight of a carried material loaded on a vehicle, inputting a weighbridge measured value, and generating a correction value, based on the weighbridge measured value inputted in the inputting and the load weight calculated in the calculating, wherein the calculating includes correcting the load weight by the correction value to calculate a corrected load weight.

### CROSS-REFERENCE TO RELATED APPLICATIONS

This application is a continuation application filed under 35 U.S.C. 111 (a) claiming benefit under 35 U.S.C. 120 and 365(c) of PCT International Application No. PCT/JP2022/016334, filed on Mar. 30, 2022, and designating the U.S., which claims priority to Japanese Patent Application No. 2021-060110 filed on Mar. 31, 2021. The entire contents of the foregoing applications are incorporated herein by reference.

### BACKGROUND

### Technical Field

The present disclosure relates to a work machine and a work machine support system.

### Description of Related Art

For example, the related art discloses a shovel that calculates the weight of excavated material such as earth and sand excavated by the excavation attachment as the excavation weight to calculate the load weight of the excavated material loaded on a dump truck.

### SUMMARY

An aspect of the present disclosure provides a work machine that includes processing circuitry, and a memory storing computer-readable instructions, which when executed by the processing circuitry, cause the work machine to perform a process including calculating a load weight of a carried material loaded on a vehicle, inputting a weighbridge measured value, and generating a correction value, based on the weighbridge measured value inputted in the inputting and the load weight calculated in the calculating, wherein the calculating includes correcting the load weight by the correction value to calculate a corrected load weight.

### BRIEF DESCRIPTION OF THE DRAWINGS

FIG. 1 is a top view illustrating an example of a yard where a shovel according to a present embodiment is used.

FIG. 2 is a side view illustrating the shovel.

FIG. 3 is a view schematically illustrating an example of a configuration of the shovel.

FIG. 4 is a view schematically illustrating an example of a configuration of a hydraulic system for the shovel.

FIG. 5 is a schematic diagram illustrating an example of a configuration relating to a carried-material weight detection function.

FIG. 6 is a block diagram illustrating processing of a carried-material weight calculation part.

FIG. 7A is a table illustrating an example of a history recorded in a storage device of the shovel.

FIG. 7B is a table illustrating an example of a history recorded in the storage device of the shovel.

### DETAILED DESCRIPTION

In a work machine that calculates the weight of a material carried by an attachment, the calculated weights of the carried material may vary depending on environmental temperatures, the skills of operators, the trajectory during carrying operations, the layout of the work machine, and the dump truck at the site, and the like. Thus, it is desirable to adjust the operation of a weight calculation part that calculates the weight of the carried material.

Accordingly, it is desirable to provide a work machine and a work machine support system to accurately calculate the weight of a carried material.

Hereinafter, an embodiment will be described with reference to drawings.

### <Yard>

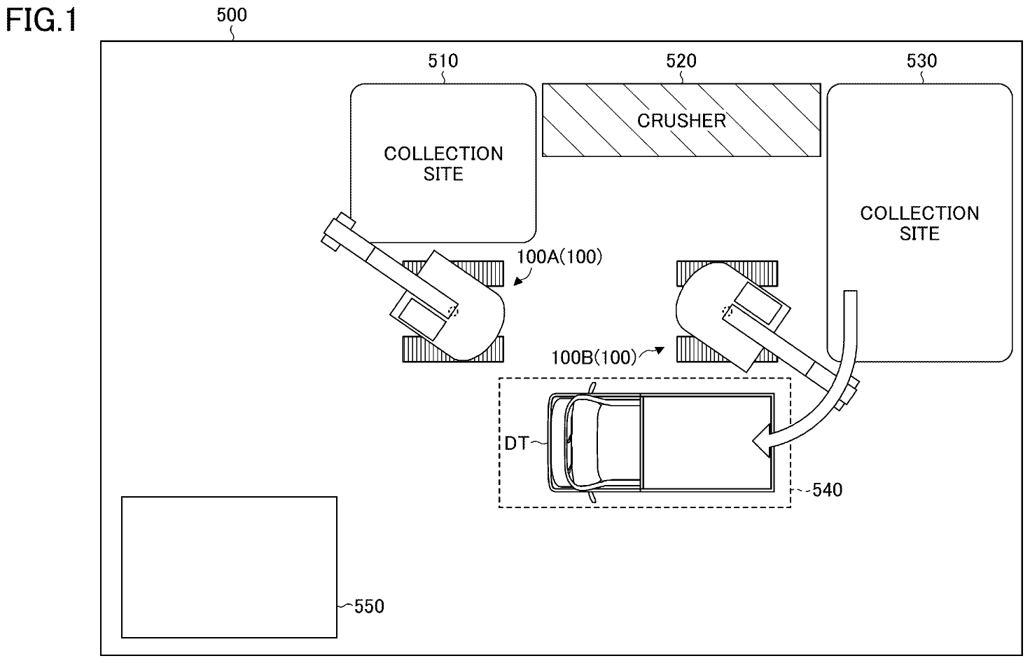

An example of a yard 500 where a shovel 100 is used will be described with reference to FIG. 1. The shovel 100 is an example of a work machine according to the present embodiment. FIG. 1 is a top view illustrating an example of a yard 500 where the shovel 100 according to the present embodiment is used.

The yard 500 is provided with, for example, a collection site 510, a work device 520, a collection site 530, a loading position 540, and a weighbridge device 550.

The shovel 100A (100) unloads scrap from a loading bed of a dump truck (not illustrated), which has come to unload the scrap to the collection site 510. The shovel 100A also puts scrap of the collection site 510 into an input port of the work device 520. The work device 520 is, for example, a crusher that crushes scrap put in through the input port. The work device 520 may be provided with a line sorting machine, a vibration sieving machine, or the like for separating the crushed scrap. The scrap (e.g., crushed and separated scrap) processed by the work device 520 is accumulated in the collection site 530.

The shovel 100B (100) loads the processed scrap (hereinafter referred to as a “carried material”) accumulated in the collection site 530 onto the loading bed of the dump truck DT that has come to load the scrap and stopped at the loading position 540. The shovel 100B (100) also has a function of calculating the weight of the carried material loaded on the loading bed of the dump truck DT in one loading operation. The shovel 100B (100) also has a function of calculating the load weight of the carried material loaded on the loading bed of the dump truck DT by summing the weight of the carried material calculated in multiple loading operations.

The weighbridge device 550 measures the weight of the dump truck DT. The dump truck DT loaded with the carried material at the loading position 540 moves from the loading position 540 to the weighbridge device 550, and the weight of the dump truck DT is measured by the weighbridge device 550. The weight of the carried material loaded on the dump truck DT (a weighbridge measured value) is calculated by subtracting the weight of the empty dump truck DT from the weight of the dump truck DT loaded with the carried material. It should be noted that the weight of the empty dump truck DT may be, for example, measured by the weighbridge device 550 when the empty dump truck DT enters the yard 500; alternatively, a table in which the type of dump truck DT is associated with the weight at the time of the empty load may be prepared in advance, and the weight at the time of the empty load may be set, based on the type of dump truck DT.

When the load weight (the weighbridge measured value) of the dump truck DT measured by the weighbridge device 550 exceeds the maximum load, the dump truck DT returns to the loading position 540, and the shovel 100B (100) unloads an exceeded amount of the carried material from the loading bed of the dump truck DT. The dump truck DT moves again from the loading position 540 to the weighbridge device 550, measures the weight of the dump truck DT again by the weighbridge device 550, and calculates the load weight (the weighbridge measured value).

On the other hand, when the load weight (the weighbridge measured value) of the dump truck DT measured by the weighbridge device 550 is insufficient with respect to the maximum load, the dump truck DT returns to the loading position 540, and the shovel 100B (100) further loads the carried material onto the loading bed of the dump truck 1′ to supplement the amount insufficient with respect to the maximum load. Then, the dump truck DT moves from the loading position 540 to the weighbridge device 550 again, measures the weight of the dump truck DT by the weighbridge device 550 again, and calculates the load weight (the weighbridge measured value).

When the exceeded load weight or insufficient load weight of the dump truck DT is eliminated, the dump truck DT leaves the yard 500 and moves to the destination.

[Overview of the Shovel]

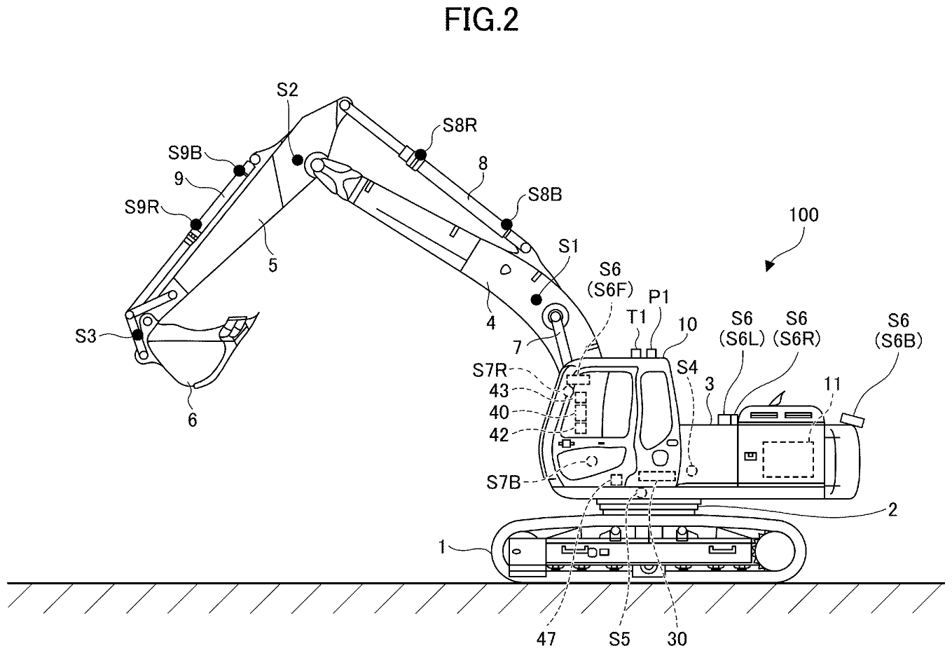

Next, an overview of the shovel 100 according to the present embodiment will be described with reference to FIG. 2.

FIG. 2 is a side view illustrating the shovel 100 according to the present embodiment.

The shovel 100 according to the present embodiment includes a lower traveling body 1, an upper turning body 3 turnably mounted on the lower traveling body 1 via a turning mechanism 2, and an attachment (a work tool). The attachment constitutes a boom 4, an arm 5, a bucket 6, and a cabin 10.

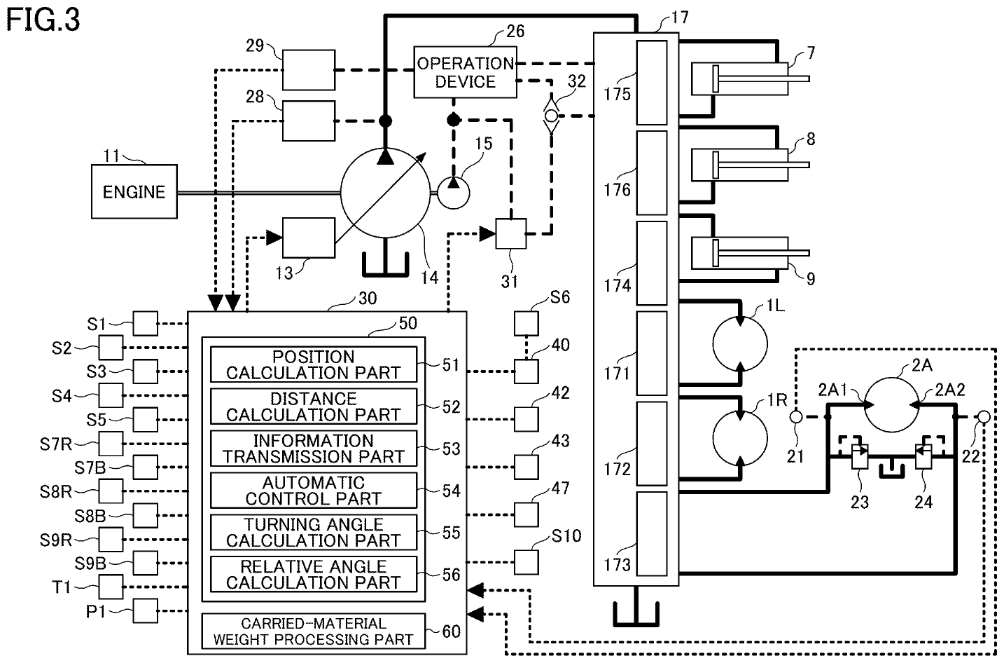

The lower traveling body 1 includes, for example, a pair of right and left crawlers, which are hydraulically driven by traveling hydraulic motors 1L and 1R, respectively (see FIG. 3 described later), to cause the shovel 100 to travel. That is, the pair of traveling hydraulic motors 1L and 1R (examples of a traveling motor) drive the lower traveling body 1 (crawler) as a driven part.

The upper turning body 3 is driven by a turning hydraulic motor 2A (see FIG. 3 described later) to turn with respect to the lower traveling body 1. That is, the turning hydraulic motor 2A is a turning driving part that drives the upper turning body 3 as a driven part, and can change the direction of the upper turning body 3.

The upper turning body 3 may be electrically driven by an electric motor (hereinafter referred to as a “turning motor”) instead of the turning hydraulic motor 2A. In other words, the turning motor, like the turning hydraulic motor 2A, is a turning driving part that drives the upper turning body 3 as a driven part to change the direction of the upper turning body 3.

The boom 4 is pivotally attached to the center of the front part of the upper turning body 3, the arm 5 is pivotally attached to the tip part of the boom 4 so as to rotate vertically, and the bucket 6 as an end attachment is pivotally attached to the tip part of the arm 5 so as to rotate vertically. The boom 4, the arm 5, and the bucket 6 are hydraulically driven by a boom cylinder 7, an arm cylinder 8, and a bucket cylinder 9, respectively, as hydraulic actuators.

The bucket 6 is an example of an end attachment, and other end attachments, such as a slope bucket, a dredging bucket, a breaker, a lifting magnet, a grapple, and the like, may be attached to the tip part of the arm 5 in place of the bucket 6, according to the contents of the work.

The cabin 10 is an operator's cabin, which is mounted on the front left side of the upper turning body 3.

[Shovel Configuration]

Next, a specific configuration of the shovel 100 according to the present embodiment will be described with reference to FIG. 3 in addition to FIG. 2.

FIG. 3 is a schematic diagram illustrating an example of a configuration of the shovel 100 according to the present embodiment.

In FIG. 3, the mechanical power system, a hydraulic oil line, a pilot line, and an electrical control system are indicated by a double line, a solid line, a dashed line, and a dotted line, respectively.

The drive system of the shovel 100 according to the present embodiment includes an engine 11, a regulator 13, a main pump 14, and a control valve 17. As described above, a hydraulic drive system of the shovel 100 according to the present embodiment includes hydraulic actuators such as traveling hydraulic motors 1L and 1R, a turning hydraulic motor 2A, a boom cylinder 7, an arm cylinder 8, and a bucket cylinder 9 for hydraulically driving the lower traveling body 1, the upper turning body 3, the boom 4, the arm 5, and the bucket 6, respectively.

The engine 11 is a main power source in the hydraulic drive system, and is mounted, for example, at the rear part of the upper turning body 3. Specifically, under direct or indirect control by the controller 30 described later, the engine 11 rotates at a predetermined target speed to drive the main pump 14 and the pilot pump 15. The engine 11 is, for example, a diesel engine fueled with diesel oil.

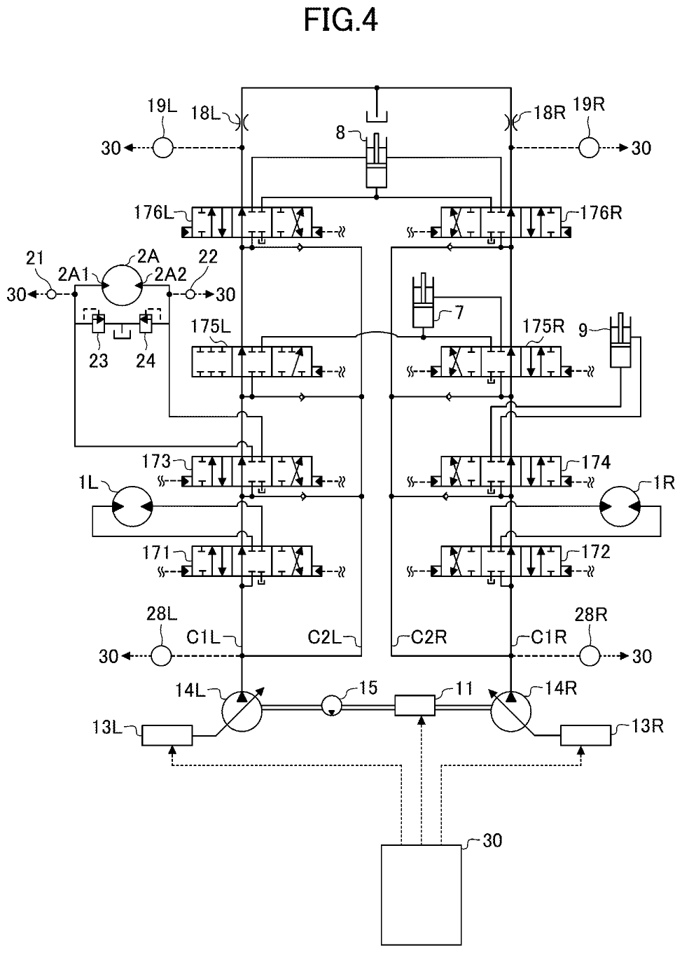

The regulator 13 controls the amount of discharge from the main pump 14. For example, the regulator 13 adjusts the angle (tilt angle) of a swashplate of the main pump 14 according to a control instruction given by the controller 30. The regulator 13 includes, for example, regulators 13L and 13R (see FIG. 4) as described later.

Like the engine 11, for example, the main pump 14 is mounted at the rear part of the upper turning body 3, and supplies a hydraulic oil to the control valve 17 through a high-pressure hydraulic line. The main pump 14 is driven by the engine 11 as described above. The main pump 14 is, for example, a variable displacement hydraulic pump, in which under the control of the controller 30 as described above, the tilt angle of the swashplate is adjusted by the regulator 13 to adjust the stroke length of a piston, thereby controlling the discharge flow rate (discharge pressure). The main pump 14 includes, for example, main pumps 14L and 14R (see FIG. 4) as described below.

The control valve 17 is a hydraulic control device that is mounted, for example, at the center of the upper turning body 3, and that controls the hydraulic drive system according to an operator's operation with respect to the operation device 26. The control valve 17 is connected to the main pump 14 via the high-pressure hydraulic line as described above, and selectively supplies hydraulic oil supplied from the main pump 14 to the hydraulic actuators (the traveling hydraulic motors 1L and 1R, the turning hydraulic motor 2A, the boom cylinder 7, the arm cylinder 8, and the bucket cylinder 9) according to the operation state of the operation device 26. Specifically, the control valve 17 includes control valves 171 to 176 for controlling the flow rate and flow direction of hydraulic oil supplied from the main pump 14 to each of the hydraulic actuators. More specifically, the control valve 171 corresponds to the traveling hydraulic motor 1L, the control valve 172 corresponds to the traveling hydraulic motor 1R, and the control valve 173 corresponds to the turning hydraulic motor 2A. The control valve 174 corresponds to the bucket cylinder 9, the control valve 175 corresponds to the boom cylinder 7, and the control valve 176 corresponds to the arm cylinder 8. The control valve 175 includes, for example, control valves 175L and 175R (see FIG. 4) as described later, and the control valve 176 includes, for example, control valves 176L and 176R (see FIG. 4) as described later. Details of the control valves 171 to 176 will be described later.

The operation system of the shovel 100 according to the present embodiment includes the pilot pump 15 and the operation device 26. The operation system of the shovel 100 includes a shuttle valve 32 as a configuration related to the machine control function by the controller 30, which will be described later.

The pilot pump 15 is installed, for example, on the rear part of the upper turning body 3, and applies pilot pressure to the operation device 26 via the pilot line. The pilot pump 15 is, for example, a fixed displacement hydraulic pump, and is driven by the engine 11 as described above.

The operation device 26 is provided near an operator's seat of the cabin 10, and is an operation input means prepared for the operator to operate various types of operating elements (such as the lower traveling body 1, the upper turning body 3, the boom 4, the arm 5, the bucket 6, and the like). In other words, the operation device 26 is an operation input means prepared for an operator to operate hydraulic actuators (i.e., the traveling hydraulic motors 1L and 1R, the turning hydraulic motor 2A, the boom cylinder 7, the arm cylinder 8, the bucket cylinder 9, and the like) for driving respective operating elements. The operation device 26 is connected to the control valve 17 either directly through the pilot line on the secondary side thereof or indirectly through the shuttle valve 32 provided on the pilot line on the secondary side. As a result, the pilot pressures corresponding to the operation states of the lower traveling body 1, the upper turning body 3, the boom 4, the arm 5, the bucket 6, and the like in the operation device 26 can be input to the control valve 17. Therefore, the control valve 17 can drive the respective hydraulic actuators according to the operation states in the operation device 26. The operation device 26 includes, for example, a lever device (not illustrated) for operating the arm 5 (the arm cylinder 8). The operation device 26 also includes, for example, lever devices for operating the boom 4 (the boom cylinder 7), the bucket 6 (the bucket cylinder 9), and the upper turning body 3 (the turning hydraulic motor 2A). The operation device 26 also includes, for example, a lever device and a pedal device for operating each of a pair of right and left crawlers (the traveling hydraulic motors 1L and 1R) of the lower traveling body 1.

The shuttle valve 32 has two inlet ports and one outlet port, and causes the outlet port to output a hydraulic oil having the higher pilot pressure among the pilot pressures input to the two inlet ports. One of the two inlet ports of the shuttle valve 32 is connected to the operation device 26, and the other is connected to a proportional valve 31. The outlet port of the shuttle valve 32 is connected through the pilot line to the pilot port of the corresponding control valve in the control valve 17. Therefore, the shuttle valve 32 can apply the higher one of the pilot pressure generated by the operation device 26 and the pilot pressure generated by the proportional valve 31 to the pilot port of the corresponding control valve. In other words, the controller 30, which will be described later, causes the proportional valve 31 to output a pilot pressure higher than the pilot pressure on the secondary side output from the operation device 26 to control the corresponding control valve, thereby controlling the operations of various types of operating elements, regardless of the operator's operation of the operation device 26.

The operation device 26 (left operation lever, right operation lever, left traveling lever, and right traveling lever) may not be a hydraulic pilot type that outputs a pilot pressure, but an electric type that outputs an electric signal. In this case, the electric signal from the operation device 26 is input to the controller 30 so that the controller 30 controls each of the control valves 171 to 176 in the control valve 17 according to the input electric signal, thereby implementing the operations of various hydraulic actuators according to the operation contents with respect to the operation device 26. For example, the control valves 171 to 176 in the control valve 17 may be a solenoid type spool valve driven by an instruction from the controller 30. Also, for example, between the pilot pump 15 and the pilot port of each of the control valves 171 to 176, a solenoid valve that operates according to an electrical signal from the controller 30 may be disposed. In this case, when a manual operation using the electric operation device 26 is performed, the controller 30 controls the solenoid valve and increases or decreases the pilot pressure by an electrical signal corresponding to the operation amount (e.g., the lever operation amount), so that each of the control valves 171 to 176 can operate according to the operation contents to the operation device 26.

The control system of the shovel 100 according to the present embodiment includes the controller 30, the discharge pressure sensor 28, the operation pressure sensor 29, the proportional valve 31, a display device 40, an input device 42, an audio output device 43, a storage device 47, a boom angle sensor S1, an arm angle sensor S2, a bucket angle sensor S3, an airframe inclination sensor S4, a turning state sensor S5, an imaging device S6, a positioning device P1, and a communication device T1.

The controller 30 (an example of a control device) is provided in the cabin 10, for example, and controls the driving of the shovel 100. The controller 30 may be implemented in any hardware, software, or combination of the hardware and software. For example, the controller 30 may be composed mainly of a microcomputer including a CPU (Central Processing Unit), a ROM (Read Only Memory), a RAM (Random Access Memory), a non-volatile auxiliary storage device, and various input/output interfaces. The controller 30 may implement various types of functions by executing various types of programs stored in, for example, a ROM or a non-volatile auxiliary storage device on the CPU. The controller 30 and the control device may, for example, mainly include processing circuitry, and a memory storing computer-readable instructions, which when executed by the processing circuitry, cause the work machine to perform a process including a given process.

For example, the controller 30 sets a target rotation speed based on a work mode or the like preset by a predetermined operation of an operator or the like, and performs drive control to make the engine 11 rotate at a constant speed.

For example, the controller 30 outputs a control instruction to the regulator 13 as necessary, and changes the discharge amount of the main pump 14.

Also, for example, the controller 30 controls a machine guidance function that guides, for example, a manual operation of the shovel 100 by the operator through the operation device 26. Also, the controller 30 controls, for example, a machine control function that automatically supports a manual operation of the shovel 100 by the operator through the operation device 26. That is, the controller 30 includes a machine guidance part 50 as a functional part related to the machine guidance function and the machine control function. In addition, the controller 30 includes a carried-material weight processing part 60 which will be described later.

Some of the functions of the controller 30 may be implemented by other controllers (control devices). That is, the functions of the controller 30 may be implemented in a manner distributed by multiple controllers. For example, the machine guidance function and the machine control function may be implemented by a dedicated controller (control device).

The discharge pressure sensor 28 detects a discharge pressure of the main pump 14. The detection signal corresponding to the discharge pressure detected by the discharge pressure sensor 28 is input in the controller 30. The discharge pressure sensor 28 includes, for example, discharge pressure sensors 28L and 28R (see FIG. 4) as described later.

The operation pressure sensor 29 detects, as described above, the pilot pressure on the secondary side of the operation device 26, that is, the pilot pressures corresponding to the operation state (e.g., operation content such as operation direction or operation amount) for each operating element (i.e., the hydraulic actuator) in the operation device 26. The detection signal of the pilot pressures corresponding to the operation states of the lower traveling body 1, the upper turning body 3, the boom 4, the arm 5, the bucket 6, and the like in the operation device 26 by the operation pressure sensor 29 is input in the controller 30.

In place of the operation pressure sensor 29, other sensors capable of detecting the operation states of the respective operating elements in the operation device 26 may be provided; such sensors may include, for example, encoders and potentiometers capable of detecting the operating amount (tilt amount) and tilt direction of the lever device, and the like.

The proportional valve 31 is provided on the pilot line connecting the pilot pump 15 and the shuttle valve 32, and is configured so as to change the flow passage area (cross-sectional area through which the hydraulic oil can flow). The proportional valve 31 operates according to a control instruction input from the controller 30. This allows the controller 30 to supply the hydraulic oil discharged from the pilot pump 15 to the pilot port of the corresponding control valve in the control valve 17 via the proportional valve 31 and the shuttle valve 32, even when the operator is not operating the operation device 26 (i.e., the lever device).

The display device 40 is provided in the cabin 10 at a location easily viewable by a seated operator, and displays various types of information images under control by the controller 30. The display device 40 may be connected to the controller 30 via an on-board communication network such as a CAN (Controller Area Network) or may be connected to the controller 30 via a one-to-one leased line.

The input device 42 is provided within reach of a seated operator in the cabin 10, receives various operation inputs by the operator, and outputs a signal corresponding to the operation input to the controller 30. The input device 42 includes a touch panel mounted on a display of a display device for displaying various types of information images, a knob switch provided at the tip part of a lever part of a lever device, a button switch, a lever, a toggle, a rotary dial, and the like installed around the display device 40. A signal corresponding to an operation content for the input device 42 is input in the controller 30.

The audio output device 43 is provided in the cabin 10, for example, and is connected to the controller 30 to output audio under the control of the controller 30. The audio output device 43 is, for example, a speaker or a buzzer. The audio output device 43 outputs various types of information according to an audio output instruction from the controller 30.

The storage device 47 is provided in the cabin 10, for example, and stores various types of information under the control of the controller 30. The storage device 47 is, for example, a nonvolatile storage medium such as a semiconductor memory. The storage device 47 may store information output by various devices during the operation of the shovel 100, and may store information acquired through various devices before the operation of the shovel 100 is started. For example, the storage device 47 may store data on a target construction plane acquired through the communication device T1 or the like, or set through the input device 42 or the like. The target construction plane may be set (stored) by the operator of the shovel 100, or may be set by the construction manager or the like.

The boom angle sensor S1 is attached to the boom 4, and detects the angle of elevation (hereinafter referred to as “a boom angle”) of the boom 4 with respect to the upper turning body 3, for example, the angle formed by a straight line connecting the fulcrum points of both ends of the boom 4 with respect to the turning plane of the upper turning body 3 in side view. The boom angle sensor S1 may include, for example, a rotary encoder, an acceleration sensor, a six-axis sensor, an inertial measurement unit (IMU), or the like. The boom angle sensor S1 may include a potentiometer using a variable resistor, a cylinder sensor configured to detect the stroke amount of a hydraulic cylinder (boom cylinder 7) corresponding to the boom angle, or the like. The same applies to the arm angle sensor S2 and the bucket angle sensor S3. The detection signal corresponding to the boom angle by the boom angle sensor S1 is input in the controller 30.

The arm angle sensor S2 is attached to the arm 5, and detects the rotation angle (hereinafter referred to as “an arm angle”) of the arm 5 with respect to the boom 4, for example, the angle formed by a straight line connecting the fulcrum points of both ends of the arm 5 with respect to the straight line connecting the fulcrum points of both ends of the boom 4 in side view. The detection signal corresponding to the arm angle by the arm angle sensor S2 is input in the controller 30.

The bucket angle sensor S3 is attached to the bucket 6, and detects the rotation angle (hereinafter referred to as “a bucket angle”) of the bucket 6 with respect to the arm 5, for example, the angle formed by a straight line connecting the fulcrum point and the tip (cutting edge) of the bucket 6 with respect to the straight line connecting the fulcrum points of both ends of the arm 5 in side view. The detection signal corresponding to the bucket angle by the bucket angle sensor S3 is input in the controller 30.

The airframe inclination sensor S4 detects the inclination state of the airframe (the upper turning body 3 or lower traveling body 1) with respect to the horizontal plane. The airframe inclination sensor S4 is, for example, attached to the upper turning body 3, and detects the inclination angles (hereinafter referred to as “a front/back inclination angle” and “a left/right inclination angle”) of the shovel 100 (i.e., the upper turning body 3) around two axes in the front/back direction and the left/right direction. The airframe inclination sensor S4 may include, for example, a rotary encoder, an acceleration sensor, a six-axis sensor, an IMU, or the like. The detection signals corresponding to the inclination angles (front/back inclination angle and left/right inclination angle) by the airframe inclination sensor S4 are input in the controller 30.

The turning state sensor S5 outputs detection information on the turning state of the upper turning body 3. The turning state sensor S5 detects, for example, the turning angular velocity and turning angle of the upper turning body 3. The turning state sensor S5 may include, for example, a gyro sensor, a resolver, a rotary encoder, and the like. The detection signal corresponding to the turning angle or the turning angular velocity of the upper turning body 3 by the turning state sensor S5 is input in the controller 30.

The imaging device S6 as a spatial recognition device images the area around a shovel 100. The imaging device S6 includes a camera S6F configured to image the front of the shovel 100, a camera S6L configured to image the left side of the shovel 100, a camera S6R configured to image the right side of the shovel 100, and a camera S6B configured to image the back of the shovel 100.

The camera S6F is mounted, for example, on the ceiling of the cabin 10, that is, inside the cabin 10. The camera S6F may also be mounted on the outside of the cabin 10, such as the roof of the cabin 10 or the side surface of the boom 4. The camera S6L is mounted on the left end of the upper surface of the upper turning body 3, the camera S6R is mounted on the right end of the upper surface of the upper turning body 3, and the camera S6B is mounted on the rear end of the upper surface of the upper turning body 3.

Each of the imaging devices S6 (cameras S6F, S6B, S6L, S6R) is, for example, a monocular wide-angle camera having a very wide angle of view. The imaging device S6 may be a stereo camera, a distance image camera, or the like. The image taken by the imaging device S6 is input in the controller 30 through the display device 40.

The imaging device S6 as a spatial recognition device may function as an object detection device. In this case, the imaging device S6 may detect an object existing around the shovel 100. The object to be detected may include, for example, a person, an animal, a vehicle, a construction machine, a building, a hole, and the like. The imaging device S6 may calculate the distance from the imaging device S6 or the shovel 100 to the recognized object. The imaging device S6 as the object detection device may include, for example, a stereo camera, a distance image sensor, and the like. The spatial recognition device is, for example, a monocular camera having an imaging element such as a CCD or a CMOS, and outputs the captured image to the display device 40. The spatial recognition device may be configured to calculate the distance from the spatial recognition device or the shovel 100 to the recognized object. In addition to the imaging device S6, another object detection device such as an ultrasonic sensor, a millimeter wave radar, a LIDAR, an infrared sensor, or the like may be provided as the spatial recognition device. When the millimeter wave radar, ultrasonic sensor, laser radar, or the like is used as the spatial recognition device, the distance and direction of the object may be detected by transmitting a large number of signals (such as laser light) to an object, and receiving the reflected signals reflected from the object.

The imaging device S6 may be directly connected to the controller 30 in a communicable manner.

A boom rod pressure sensor S7R and a boom bottom pressure sensor 57B are attached to the boom cylinder 7. An arm rod pressure sensor S8R and an arm bottom pressure sensor S8B are attached to the arm cylinder 8. A bucket rod pressure sensor S9R and a bucket bottom pressure sensor S9B are attached to the bucket cylinder 9. The boom rod pressure sensor S7R, the boom bottom pressure sensor S7B, the arm rod pressure sensor S8R, the arm bottom pressure sensor S8B, and the bucket rod pressure sensor S9R and the bucket bottom pressure sensor S9B are collectively referred to as “cylinder pressure sensors”.

The boom rod pressure sensor S7R detects a pressure (hereinafter referred to as “a boom rod pressure”) in the rod-side oil chamber of the boom cylinder 7, and the boom bottom pressure sensor S7B detects a pressure (hereinafter referred to as “a boom bottom pressure”) in the bottom-side oil chamber of the boom cylinder 7. The arm rod pressure sensor S8R detects the pressure (hereinafter referred to as “arm rod pressure” will be used.) of the rod-side oil chamber of the arm cylinder 8, and the arm bottom pressure sensor S8B detects the pressure (hereinafter referred to as “arm bottom pressure”.) of the bottom-side oil chamber of the arm cylinder 8. The bucket rod pressure sensor S9R detects a pressure (hereinafter referred to as “a bucket rod pressure”) of the rod-side oil chamber of the bucket cylinder 9, and the bucket bottom pressure sensor S9B detects a pressure (hereinafter referred to as “bucket bottom pressure”) of the bottom-side oil chamber of the bucket cylinder 9.

A temperature sensor S10 configured to detect a temperature of a hydraulic oil is also provided. For example, the temperature sensor 510 may be provided in the hydraulic oil tank to detect the temperature of the hydraulic oil in the hydraulic oil tank. Further, the temperature sensor S10 may be provided in a hydraulic oil flow passage to supply the hydraulic oil discharged from the main pump 14 to the hydraulic actuator such as the boom cylinder 7 to detect the temperature of the hydraulic oil supplied to the hydraulic actuator. Further, the temperature sensor S10 may detect the temperature of the hydraulic oil in the hydraulic actuator, for example. For example, the temperature sensor S10 may be provided to detect the temperature of the hydraulic oil in a chamber at the bottom side of the boom cylinder 7. The temperature of the hydraulic oil detected by the temperature sensor S10 is input to the controller 30.

The positioning device P1 measures a position and an orientation of the upper turning body 3. The positioning device P1 is, for example, a GNSS (Global Navigation Satellite System) compass, which detects a position and an orientation of the upper turning body 3, and the detection signals corresponding to the position and orientation of the upper turning body 3 are input in the controller 30. The function of detecting the orientation of the upper turning body 3 among the functions of the positioning device P1 may be replaced by an orientation sensor attached to the upper turning body 3.

The communication device T1 communicates with external devices through a predetermined network that includes a mobile communication network, a satellite communication network, an Internet network, or the like, terminating at the base station. The communication device T1 is, for example, a mobile communication module corresponding to a mobile communication standard, such as LTE (Long Term Evolution), 4G (4th Generation), 5G (5th Generation), or a satellite communication module for connecting to a satellite communication network.

The machine guidance part 50 executes, for example, control of the shovel 100 related to the machine guidance function. The machine guidance part 50 transmits, for example, work information such as a distance between the target construction plane and a tip part of the attachment, that is, the work part of the end attachment, to the operator through the display device 40, the audio output device 43, or the like. Data on the target construction plane is previously stored in the storage device 47, for example, as described above. The data on the target construction plane is expressed, for example, in a reference coordinate system. The reference coordinate system is, for example, the world geodetic system. The world geodetic system is a three-dimensional rectangular XYZ coordinate system with the origin at the center of gravity of the earth, the X-axis in the direction of the intersection of the Greenwich meridian and the equator, the Y-axis in the direction of 90 degrees east longitude, and the Z-axis in the direction of the north pole. The operator may set a desired point in the construction site as a reference point, and set the target construction plane according to the relative position relation with the reference point through the input device 42. The work part of the bucket 6 is, for example, claw ends of the bucket 6, a back face of the bucket 6, and the like. When, for example, a breaker is adopted instead of the bucket 6 as an end attachment, a tip part of the breaker corresponds to the work part. The machine guidance part 50 notifies the operator of the work information through the display device 40, the audio output device 43, and the like, and guides the operator to operate the shovel 100 through the operation device 26.

The machine guidance part 50 executes, for example, the control of the shovel 100 related to the machine control function. The machine guidance part 50 may, for example, automatically operate at least one of the boom 4, the arm 5, and the bucket 6 so that the target construction plane matches the tip position of the bucket 6 when the operator is performing a manual scooping operation.

The machine guidance part 50 acquires information from the boom angle sensor S1, the arm angle sensor S2, the bucket angle sensor S3, the airframe inclination sensor S4, the turning state sensor S5, the imaging device S6, the positioning device P1, the communication device T1, the input device 42, and the like. The machine guidance part 50 calculates, for example, the distance between the bucket 6 and the target construction plane based on the acquired information, notifies the operator of the length of the distance between the bucket 6 and the target construction plane by audio from the audio output device 43 and the image displayed on the display device 40, and automatically controls the operation of the attachment such that the tip part of the attachment (i.e., a work part such as the claws or the back surface of the bucket 6) matches the target construction plane. The machine guidance part 50 includes a position calculation part 51, a distance calculation part 52, an information transmission part 53, an automatic control part 54, a turning angle calculation part 55, and a relative angle calculation part 56 as detailed functional configurations related to the machine guidance function and the machine control function.

The position calculation part 51 calculates the position of a predetermined positioning object. For example, the position calculation part 51 calculates coordinate points in the reference coordinate system of the tip part of the attachment, that is, the work part such as the claws or the back surface of the bucket 6. Specifically, the position calculation part 51 calculates coordinate points of the work part of the bucket 6 from the respective angles of elevation (the boom angle, the arm angle, and the bucket angle) of the boom 4, the arm 5, and the bucket 6.

The distance calculation part 52 calculates a distance between the two positioning objects. For example, the distance calculation part 52 calculates the distance between the tip part of the attachment, that is, the work part such as the claws or the back surface of the bucket 6 and the target construction plane. The distance calculation part 52 may calculate the angle (relative angle) between the back surface of the bucket 6 as the work part and the target construction plane.

The information transmission part 53 transmits (notifies) various kinds of information to the operator of the shovel 100 through predetermined notification means such as a display device 40 and an audio output device 43. The information transmission part 53 notifies the operator of the shovel 100 of the length (extent) of various distances, and the like calculated by the distance calculation part 52. For example, at least one of visual information by the display device 40 and auditory information by the audio output device 43 is used to transmit the distance (the length) between the tip part of the bucket 6 and the target construction plane to the operator. In addition, the information transmission part 53 may transmit the relative angle (degrees) between the back surface of the bucket 6 as a work part and the target construction plane to the operator using at least one of visual information by the display device 40 and auditory information by the audio output device 43.

Specifically, the information transmission part 53 transmits the length of the distance (e.g., vertical distance) between the work part of the bucket 6 and the target construction plane to the operator using an intermittent sound by the audio output device 43. In this case, the information transmission part 53 may shorten the interval of the intermittent sound as the vertical distance decreases, and increase the interval of the intermittent sound as the vertical distance increases. Further, the information transmission part 53 may use a continuous sound, and may express a difference in the length of the vertical distance while varying the pitch, the intensity, and the like of the sound. Further, the information transmission part 53 may issue an alarm through the audio output device 43 when the tip part of the bucket 6 becomes lower than the target construction plane, that is, the tip part of the bucket 6 exceeds the target construction plane. The alarm is, for example, a continuous sound significantly larger than an intermittent sound.

In addition, the information transmission part 53 may display the length of the distance between the tip part of the attachment, that is, the work part of the bucket 6 and the target construction plane, the degrees of the relative angle between the back surface of the bucket 6 and the target construction plane, and the like, as work information on the display device 40. Under the control of the controller 30, the display device 40 displays the work information received from the information transmission part 53 together with, for example, the image data received from the imaging device S6. The information transmission part 53 may transmit the length of the vertical distance to the operator using, for example, an image of an analog meter or an image of a bar graph indicator.

The automatic control part 54 automatically supports the operator's manual operation of the shovel 100 through the operation device 26 by automatically operating the actuator. Specifically, the automatic control part 54 can individually and automatically adjust the pilot pressure acting on the control valve (i.e., the control valve 173, the control valves 175L, 175R, and the control valve 174) corresponding to multiple hydraulic actuators (i.e., the turning hydraulic motor 2A, the boom cylinder 7, and the bucket cylinder 9) as described later. Thus, the automatic control part 54 can automatically operate the respective hydraulic actuators. Control of the machine control function by the automatic control part 54 may be executed when, for example, a predetermined switch included in the input device 42 is depressed. The predetermined switch may be, for example, a machine control switch (“MC (Machine Control Switch)”) and may be disposed as a knob switch at the tip part of the operator's grip of the operation device 26 (e.g., a lever device corresponding to the operation of the arm 5). Hereinafter, a description will proceed on the assumption that the machine control function be effective when the MC switch is depressed.

For example, when the MC switch or the like is depressed, the automatic control part 54 automatically expands and contracts at least one of the boom cylinder 7 and the bucket cylinder 9 according to the operation of the arm cylinder 8 in order to support excavation work and shaping work. Specifically, the automatic control part 54 automatically expands and contracts at least one of the boom cylinder 7 and the bucket cylinder 9 so that the target construction plane matches the position of the work part such as the claws or the back surface of the bucket 6 when the operator is manually performing the closing operation (“Arm closing operation”) of the arm 5. In this case, for example, the operator can close the arm 5 while making the claws and the like of the bucket 6 match the target construction plane by simply performing the arm closing operation of the lever device corresponding to the operation of the arm 5.

In addition, when the MC switch and the like are depressed, the automatic control part 54 may automatically rotate the turning hydraulic motor 2A (an example of an actuator) in order to make the upper turning body 3 face the target construction plane. Hereinafter, the control by the controller 30 (the automatic control part 54) to make the upper turning body 3 face the target construction plane is referred to as “facing control”. As a result, the operator or the like can make the upper turning body 3 face the target construction plane by simply pressing a predetermined switch or by simply operating the lever device described later corresponding to the turning operation while the switch is depressed. In addition, the operator can make the upper turning body 3 face the target construction plane and start the machine control function for the excavation work of the target construction plane or the like by simply pressing the MC switch.

For example, when the upper turning body 3 of the shovel 100 faces the target construction plane, the tip part (e.g., claw ends or the back surface as a work part of the bucket 6) of the attachment can be readily moved along the inclined direction of the target construction plane according to the operation of the attachment. Specifically, when the upper turning body 3 of the shovel 100 faces the target construction plane, the operation surface (attachment operation surface) of the attachment perpendicular to the turning plane of the shovel 100 includes the normal to the target construction plane corresponding to the cylindrical body (in other words, in the state along the normal).

When the attachment operation surface of the shovel 100 does not include the normal to the target construction plane corresponding to the cylindrical body, the tip part of the attachment cannot move the target construction plane in the inclined direction. As a result, the shovel 100 cannot properly construct the target construction plane. On the other hand, the automatic control part 54 automatically rotates the turning hydraulic motor 2A, so that the upper turning body 3 can face the target construction plane. Thus, the shovel 100 can properly construct the target construction plane.

The automatic control part 54 determines that the shovel faces the target construction plane when, for example, the left-most vertical distance (hereinafter simply referred to as “left vertical distance”) between the left-most coordinate point of the claw ends of the bucket 6 and the target construction plane is equal to the right-most vertical distance (hereinafter simply referred to as “right-most vertical distance”) between the right-most coordinate point of the claw ends of the bucket 6 and the target construction plane in the facing control. The automatic control part 54 may also determine that the shovel 100 faces the target construction plane when the difference between the left-most vertical distance and the right-most vertical distance is equal to or less than a predetermined value (i.e., when the difference between the left vertical distance and the right vertical distance becomes zero).

In addition, the automatic control part 54 may operate the turning hydraulic motor 2A based on the difference between the left-most vertical distance and the right-most vertical distance, for example, in the facing control. Specifically, when the lever device corresponding to the turning operation is operated while a predetermined switch such as the MC switch is depressed, whether the lever device has been operated in the direction of making the upper turning body 3 face the target construction plane is determined. For example, when the lever device is operated in the direction of increasing the vertical distance between the claw ends of the bucket 6 and the target construction plane, the automatic control part 54 does not execute the facing control. On the other hand, when the turning operation lever is operated in the direction of decreasing the vertical distance between the claw ends of the bucket 6 and the target construction plane, the automatic control part 54 executes the facing control. As a result, the automatic control part 54 can operate the turning hydraulic motor 2A such that the difference between the left vertical distance and the right vertical distance is decreased. Thereafter, the automatic control part 54 stops the turning hydraulic motor 2A when the difference is less than or equal to a predetermined value or becomes zero. Further, the automatic control part 54 may set a turning angle when the difference is less than or equal to the predetermined value or becomes zero as a target angle, and control the operation of the turning hydraulic motor 2A such that the angle difference between the target angle and the current turning angle (i.e., the detection value based on the detection signal of the turning state sensor S5) becomes zero. In this case, the turning angle is, for example, the angle of the front and rear axes of the upper turning body 3 with respect to the reference direction.

As described above, when the turning motor is installed in the shovel 100 instead of the turning hydraulic motor 2A, the automatic control part 54 performs the facing control with the turning motor (an example of an actuator) as a control object.

The turning angle calculation part 55 calculates the turning angle of the upper turning body 3. Thus, the controller 30 can specify the current orientation of the upper turning body 3. For example, the turning angle calculation part 55 calculates the angle of the front and rear axes of the upper turning body 3 relative to the reference direction as the turning angle based on the output signal of the GNSS compass included in the positioning device P1. The turning angle calculation part 55 may calculate the turning angle based on the detection signal of the turning state sensor S5. When the reference point is set at the construction site, the turning angle calculation part 55 may use the direction in which the reference point is viewed from the turning axis as the reference direction.

The turning angle indicates the direction in which the attachment working surface extends relative to the reference direction. The attachment working surface is, for example, a virtual plane that traverses the attachment and is disposed perpendicular to the turning plane. The turning plane is, for example, a virtual plane that includes the bottom surface of the turning frame perpendicular to the turning axis. The controller 30 (the machine guidance part 50) determines, for example, that the upper turning body 3 faces the target construction plane when the attachment operation plane includes the normal to the target construction plane.

The relative angle calculation part 56 calculates the turning angle (relative angle) required to make the upper turning body 3 face the target construction plane. The relative angle is, for example, a relative angle formed between the direction of the front and rear axes of the upper turning body 3 when the upper turning body 3 faces the target construction plane and the current direction of the front and rear axes of the upper turning body 3. The relative angle calculation part 56 calculates the relative angle based, for example, on data on the target construction plane stored in the storage device 47 and the turning angle calculated by the turning angle calculation part 55.

When a lever device corresponding to the turning operation is operated in a state where a predetermined switch such as an MC switch is depressed, the automatic control part 54 determines whether the turning operation has been performed in a direction to make the upper turning body 3 face the target construction plane. When the automatic control part 54 determines that the turning operation has been performed in the direction to make the upper turning body 3 face the target construction plane, the relative angle calculated by the relative angle calculation part 56 is set as the target angle. When the change in the turning angle after the lever device is operated reaches the target angle, the automatic control part 54 may determine that the upper turning body 3 faces the target construction plane, and may stop the movement of the turning hydraulic motor 2A. Thus, the automatic control part 54 can make the upper turning body 3 face the target construction plane on the assumption of the configuration illustrated in FIG. 3. In the above embodiment of the facing control, an example of facing control with respect to the target construction plane is illustrated, but the configuration is not limited to this example. For example, in the scooping operation when loading a temporarily placed carried material on a dump truck, a target excavation track corresponding to the target volume may be generated, and the facing control of the turning operation may be performed so that the attachment faces the target excavation track. In this case, the target excavation track is changed every time the scooping operation is performed. Therefore, after the earth is discharged into the dump truck, the target excavation track is controlled such that the target excavation track faces the newly changed target excavation track.

The turning hydraulic motor 2A has a first port 2A1 and a second port 2A2. The hydraulic sensor 21 detects the pressure of the hydraulic oil in the first port 2A1 of the turning hydraulic motor 2A. The hydraulic sensor 22 detects the pressure of the hydraulic oil in the second port 2A2 of the turning hydraulic motor 2A. The detection signal corresponding to the discharge pressure detected by the hydraulic sensors 21 and 22 is input in the controller 30.

The first port 2A1 is connected to the hydraulic oil tank via a relief valve 23. The relief valve 23 is opened when the pressure on the first port 2A1 side reaches a predetermined relief pressure, and the hydraulic oil on the first port 2A1 side is discharged into the hydraulic oil tank. Similarly, the second port 2A2 is connected to the hydraulic oil tank via a relief valve 24. The relief valve 24 is opened when the pressure on the second port 2A2 side reaches a predetermined relief pressure, and the hydraulic oil on the second port 2A2 side is discharged into the hydraulic oil tank.

[Shovel Hydraulic System]

Next, the hydraulic system of the shovel 100 according to the present embodiment will be described with reference to FIG. 4.

FIG. 4 is a schematic diagram illustrating an example of the configuration of the hydraulic system of the shovel 100 according to the present embodiment.

In FIG. 4, the mechanical power system, the hydraulic oil line, the pilot line, and the electrical control system are illustrated by double lines, solid lines, dashed lines, and dotted lines, respectively, as in FIG. 3 and the like.

The hydraulic system implemented by the hydraulic circuit circulates hydraulic oil from each of the main pumps 14L and 14R driven by the engine 11 to the hydraulic oil tank via the center bypass oil passages C1L and C1R, and the parallel oil passages C2L and C2R.

The center bypass oil passages C1L pass through the control valves 171, 173, 175L, and 176L disposed in the control valve 17 in order from the main pump 14L to the hydraulic oil tank.

The center bypass oil passage C1R passes through the control valves 172, 174, 175R, and 176R disposed in the control valve 17 in order from the main pump 14R to the hydraulic oil tank.

The control valve 171 is a spool valve configured to supply the hydraulic oil discharged from the main pump 14L to the traveling hydraulic motor 1L, and discharge the hydraulic oil discharged from the traveling hydraulic motor 1L to the hydraulic oil tank.

The control valve 172 is a spool valve configured to supply the hydraulic oil discharged from the main pump 14R to the traveling hydraulic motor 1R, and discharge the hydraulic oil discharged from the traveling hydraulic motor 1R to the hydraulic oil tank.

The control valve 173 is a spool valve configured to supply the hydraulic oil discharged from the main pump 14L to the turning hydraulic motor 2A, and discharge the hydraulic oil discharged from the turning hydraulic motor 2A to the hydraulic oil tank.

The control valve 174 is a spool valve configured to supply the hydraulic oil discharged from the main pump 14R to the bucket cylinder 9, and discharge the hydraulic oil in the bucket cylinder 9 to the hydraulic oil tank.

The control valves 175L and 175R are spool valves configured to supply hydraulic oil discharged from each of the main pumps 14L and 14R to the boom cylinder 7, and discharge the hydraulic oil in the boom cylinder 7 to the hydraulic oil tank.

The control valves 176L and 176R are spool valves configured to supply the hydraulic oil discharged from each of the main pumps 14L and 14R to the arm cylinder 8, and discharge the hydraulic oil in the arm cylinder 8 to the hydraulic oil tank.

The control valves 171, 172, 173, 174, 175L, 175R, 176L, and 176R respectively adjust the flow rate of the hydraulic oil supplied to and discharged from the hydraulic actuator, and switch the flow direction according to the pilot pressure acting on the pilot port.

The parallel oil passage C2L supplies the hydraulic oil of the main pump 14L to the control valves 171, 173, 175L, and 176L in parallel with the center bypass oil passage C1L. Specifically, the parallel oil passage C2L branches from the center bypass oil passage C1L on the upstream side of the control valve 171, and is configured to supply the hydraulic oil of the main pump 14L in parallel with each of the control valves 171, 173, 175L, and 176R. Thus, the parallel oil passage C2L can supply the hydraulic oil to the control valve located on the more downstream side when the hydraulic oil flow through the center bypass oil passage C1L is restricted or blocked by any of the control valves 171, 173, and 175L.

The parallel oil passage C2R supplies the hydraulic oil of the main pump 14R to the control valves 172, 174, 175R, and 176R in parallel with the center bypass oil passage C1R. Specifically, the parallel oil passage C2R branches from the center bypass oil passage C1R on the upstream side of the control valve 172, and is configured to supply the hydraulic oil of the main pump 14R in parallel with each of the control valves 172, 174, 175R, and 176R. The parallel oil passage C2R can supply the hydraulic oil to the control valve located on the more downstream side when the hydraulic oil flow through the center bypass oil passage C1R is restricted or blocked by any of the control valves 172, 174, and 175R.

The regulators 13L and 13R adjust the discharge amount of the main pumps 14L and 14R by adjusting the angle of inclination of each of the swashplates of the main pumps 14L and 14R, under the control of the controller 30.

The discharge pressure sensor 28L detects the discharge pressure of the main pump 14L, and the detection signal corresponding to the detected discharge pressure is input in the controller 30. The same applies to the discharge pressure sensor 28R. Thus, the controller 30 can control the regulators 13L and 13R according to the discharge pressures of the main pumps 14L and 14R.

The center bypass oil passages C1L and C1R are provided with respective negative control apertures (hereinafter referred to as “negative control apertures”) 18L and 18R between the control valves 176L and 176R located at the most downstream and the hydraulic oil tank. Thus, the flow of hydraulic oil discharged by the main pumps 14L and 14R is limited by the negative control apertures 18L and 18R. The negative control apertures 18L and 18R generate a control pressure (hereinafter referred to as “negative control pressure”) for controlling the regulators 13L and 13R.

The negative control pressure sensors 19L and 19R detect the negative control pressures, and the detection signals corresponding to the detected negative control pressures are input in the controller 30.

The controller 30 may control the regulators 13L and 13R and adjust the discharge amounts of the main pumps 14L and 14R according to the discharge pressures of the main pumps 14L and 14R detected by the discharge pressure sensors 28L and 28R. For example, the controller 30 may reduce the discharge amount by controlling the regulator 13L, and adjust the swashplate tilt angle of the main pump 14L according to the increase in the discharge pressure of the main pump 14L. The same applies to the regulator 13R. Thus, the controller 30 can control the total horsepower of the main pumps 14L and 14R so that the absorbed horsepower of the main pumps 14L and 14R expressed by the product of the discharge pressure and the discharge amount does not exceed the output horsepower of the engine 11.

Further, the controller 30 may control the regulators 13L and 13R and adjust the discharge amounts of the main pumps 14L and 14R according to the negative control pressures detected by the negative control pressure sensors 19L and 19R. For example, the controller 30 reduces the discharge amounts of the main pumps 14L and 14R as the negative control pressures are larger, and increases the discharge amounts of the main pumps 14L and 14R as the negative control pressures are smaller.

Specifically, when the hydraulic actuators in the shovel 100 are in a standby state (the state illustrated in FIG. 4) in which none of the hydraulic actuators are operated, the hydraulic oil discharged from the main pumps 14L and 14R passes through the center bypass oil passages C1L and C1R to the negative control apertures 18L and 18R. The flow of hydraulic oil discharged from the main pumps 14L and 14R increases the negative control pressures generated upstream of the negative control apertures 18L and 18R. As a result, the controller 30 reduces the discharge amounts of the main pumps 14L and 14R to the minimum allowable discharge amounts, and prevents the pressure loss (pumping loss) when the discharged hydraulic oil passes through the center bypass oil passages C1L and C1R.

On the other hand, when any hydraulic actuator is operated through the operation device 26, the hydraulic oil discharged from the main pumps 14L and 14R flows into the hydraulic actuator to be operated through the control valve corresponding to the hydraulic actuator to be operated. The flow of hydraulic oil discharged from the main pumps 14L and 14R reduces or eliminates the amount reaching the negative control apertures 18L and 18R, and lowers the negative control pressures generated upstream of the negative control apertures 18L and 18R. As a result, the controller 30 can increase the discharge amounts of the main pumps 14L and 14R, circulate sufficient hydraulic oil to the hydraulic actuator to be operated, and reliably drive the hydraulic actuator to be operated.

[Details of the Configuration of the Weight Detection Function of the Shovel]

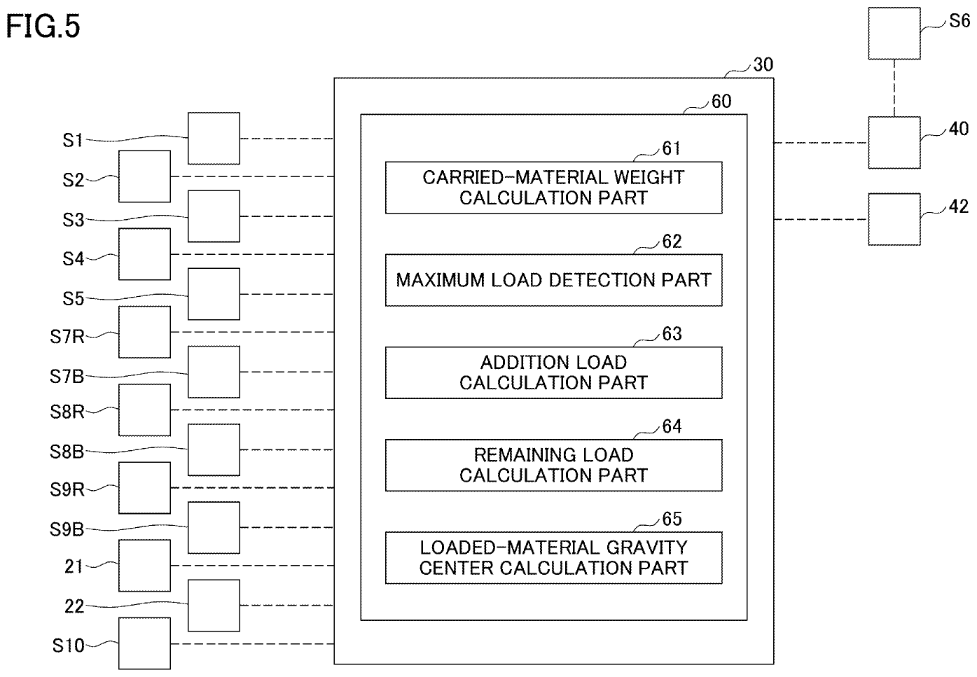

Next, with reference to FIG. 5, details of the configuration of the weight detection function of the shovel 100 according to the present embodiment will be described. FIG. 5 is a schematic diagram illustrating an example of the configuration of the weight detection function for the shovel 100 according to the present embodiment.

As described above in FIG. 3, the controller 30 includes the carried-material weight processing part 60 as a functional part related to a weight detection function of the carried material carried by the bucket 6.

The carried-material weight processing part 60 includes a carried-material weight calculation part 61, a maximum load detection part 62, an addition load calculation part 63, a remaining load calculation part 64, and a loaded-material gravity center calculation part 65.

Herein, an example of an operation of loading a carried material to the dump truck by the shovel 100 according to the present embodiment will be described.

First, at the scooping position, the shovel 100 controls the attachment and scoops up the carried material in the collection site 530 (see FIG. 1) by the bucket 6 (scooping operation). Next, the shovel 100 turns the upper turning body 3 and moves the bucket 6 from the scooping position to the discharging position (turning operation). A loading bed of the dump truck DT is disposed below the discharging position. Next, at the discharging position, the shovel 100 controls the attachment to discharge the carried material in the bucket 6, thereby loading the carried material in the bucket 6 onto the loading bed of the dump truck DT (loading operation). Next, the shovel 100 turns the upper turning body 3 to move the bucket 6 from the discharging position to the scooping position (turning operation). By repeating these operations, the shovel 100 loads the scooped carried material onto the loading bed of the dump truck.

The carried-material weight calculation part 61 calculates the weight of the carried material in the bucket 6. The carried-material weight calculation part 61 calculates the weight of the carried material based on the thrust of the boom cylinder 7. The method of calculating the weight of the carried material in the carried-material weight calculation part 61 will be described later.

The maximum load detection part 62 detects the maximum load of the dump truck DT to be loaded with the carried material. For example, the maximum load detection part 62 specifies the dump truck DT to be loaded with the carried material based on the image captured by the imaging device S6. Next, the maximum load detection part 62 detects the maximum load of the dump truck DT based on the specified image of the dump truck DT. For example, the maximum load detection part 62 determines the type (size, and the like) of the dump truck DT based on the specified image of the dump truck DT. The maximum load detection part 62 has a table which associates the type of vehicle with the maximum load, and determines the maximum load of the dump truck DT, based on the type of vehicle determined from the image and the table. The input device 42 inputs the maximum load of the dump truck DT, the type of vehicle, and the like, and the maximum load detection part 62 may determine the maximum load of the dump truck DT, based on the input information of the input device 42.

The addition load calculation part 63 calculates the weight (the load weight) of the carried material loaded on the dump truck DT. That is, every time the carried material in the bucket 6 is discharged on the loading bed of the dump truck DT, the addition load calculation part 63 adds the weight of the carried material in the bucket 6 calculated by the carried-material weight calculation part 61 to calculate the added up load (the load weight, the total weight), which is the sum of the weights of the carried material loaded on the loading bed of the dump truck DT. When the dump truck DT for loading the carried material is switched to a new dump truck DT, the added up load is reset.

The remaining load calculation part 64 calculates a difference between the maximum load of the dump truck DT detected by the maximum load detection part 62 and the current added up load calculated by the addition load calculation part 63 as a remaining load. The remaining load is the weight of the remaining carried material that can be loaded on the dump truck DT.

The loaded-material gravity center calculation part 65 calculates the center of gravity of the carried material in the bucket 6. For example, the loaded-material gravity center calculation part 65 may calculate the center of gravity of the carried material based on the values of the boom angle sensor S1, the arm angle sensor S2, the bucket angle sensor S3, and the like, assuming that the positional relationship between the claw position of the bucket 6 and the center of gravity of the carried material is known. The calculation method is not limited to this method, and various methods can be used.

The display device 40 may display the weight of the carried material in the bucket 6 calculated by the carried-material weight calculation part 61, the maximum load of the dump truck DT detected by the maximum load detection part 62, the added up load of the dump truck DT calculated by the addition load calculation part 63 (the sum of the weights of the carried material loaded on the weighbridge device), and the remaining load of the dump truck DT calculated by the remaining load calculation part 64 (the weight of the remaining carried material).

The display device 40 may be configured to issue a warning when the added up load exceeds the maximum load. The display device 40 may be configured to issue a warning when the calculated weight of the carried material in the bucket 6 exceeds the remaining load. The warning is not limited to being displayed on the display device 40, and may be audio output by the audio output device 43. As a result, the carried material may be prevented from being loaded beyond the maximum load of the dump truck DT.

[Method of Calculating Weight of Carried Material]

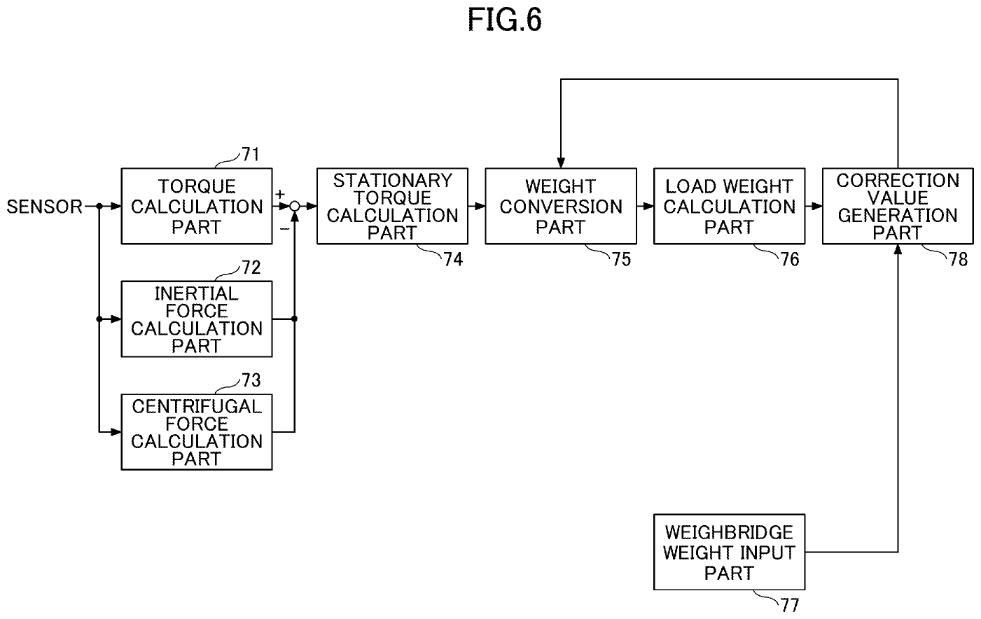

Next, with reference to FIG. 6, a method of calculating the weight of the carried material in the bucket 6 by the carried-material weight calculation part 61, based on the thrust of the boom cylinder 7 will be described. The carried-material weight calculation part 61 is configured to calculate the weight of the carried material.

FIG. 6 is a block diagram illustrating processing of the carried-material weight calculation part 61. The carried-material weight calculation part 61 includes a torque calculation part 71, an inertia force calculation part 72, a centrifugal force calculation part 73, a stationary torque calculation part 74, a weight conversion part 75, a load weight calculation part 76, a weighbridge weight input part 77, and a correction value generation part 78.

The torque calculation part 71 calculates torque (detected torque) around the foot pin of the boom 4. The torque is calculated based on the pressure (the boom rod pressure sensor S7R, the boom bottom pressure sensor S7B) of the hydraulic oil of the boom cylinder 7.

The inertia force calculation part 72 calculates the torque (inertia term torque) around the foot pin of the boom 4 due to the inertia force. The inertia term torque is calculated based on the angular acceleration around the foot pin of the boom 4 and the moment of inertia of the boom 4. The angular acceleration and the moment of inertia around the foot pin of the boom 4 are calculated based on the output of the attitude sensor.

The centrifugal force calculation part 73 calculates the torque (centrifugal term torque) around the foot pin of the boom 4 due to the Coriolis and centrifugal forces. The centrifugal term torque is calculated based on the angular velocity around the foot pin of the boom 4 and the weight of the boom 4. The angular velocity around the foot pin of the boom 4 is calculated based on the output of the attitude sensor. The weight of the boom 4 is known.

The stationary torque calculation part 74 calculates the stationary torque τ_{W}, which is the torque around the foot pin of the boom 4 when the attachment is stationary, based on the detected torque of the torque calculation part 71, the inertia term torque of the inertia force calculation part 72, and the centrifugal term torque of the centrifugal force calculation part 73. The torque around the foot pin of the boom 4 is represented by Equation (1). The τ on the left side of Equation (1) indicates the detected torque, the first term on the right side indicates the inertial term torque, the second term on the right side indicates the centrifugal term torque, and the third term on the right side indicates the stationary torque τ_{W}.

[Equation 1]

τ=J\ddot{θ}+h(\dot{θ},θ)\dot{θ}+τ_{W} (1)

As illustrated in Equation (1), the stationary torque τ_{W} can be calculated by subtracting the inertial term torque and the centrifugal term torque from the detected torque τ. As a result, in the present embodiment, this enables compensating for the effect caused by the rotating operation around a pin such as of the boom.

The weight conversion part 75 calculates the weight W₁ of the carried material, based on the stationary torque τ₁. The weight W₁ of the carried material can be calculated, for example, by dividing the torque, which is obtained by subtracting the torque when the carried material is not loaded in the bucket 6 from the stationary torque Tw, by the horizontal distance from the foot pin of the boom 4 to the center of gravity of the carried material. The torque when the carried material is not loaded in the attachment may be calculated, for example, based on the respective positions of the centers of gravity of the boom 4, the arm 5, and the bucket 6, which are calculated based on the detected values of the boom angle sensor S1, the arm angle sensor S2, and the bucket angle sensor S3, and the respective weights of the boom 4, the arm 5, and the bucket 6. The horizontal distance from the foot pin of the boom 4 to the center of gravity of the carried material may be calculated based on the position of the center of gravity of the carried material calculated by the loaded-material gravity center calculation part 65. As described above, the carried-material weight calculation part 61 can calculate the weight W₁ of the carried material by compensating the inertia term and the centrifugal term in the operation of the boom 4.

The weight conversion part 75 outputs the weight W of the carried material (=α×W₁) obtained by integrating the correction coefficient α generated by a correction value generation part 78 described later with the calculated weight W₁ of the carried material. The initial value of the correction coefficient α is 1.

Alternatively, the weight conversion part 75 outputs the weight W(=W₁+β) of the carried material obtained by adding the offset value β generated by the correction value generation part 78 described later to the calculated weight W₁ of the carried material. The initial value of the offset value β is set to 0.

The load weight calculation part 76, like the addition load calculation part 63 (see FIG. 5), adds the weight W of the carried material calculated by the weight conversion part 75 every time the carried material in the bucket 6 is discharged onto the loading bed of the dump truck DT to calculate the load weight (the added up load, the total weight), which is the sum of the weights of the carried materials loaded on the loading bed of the dump truck DT.

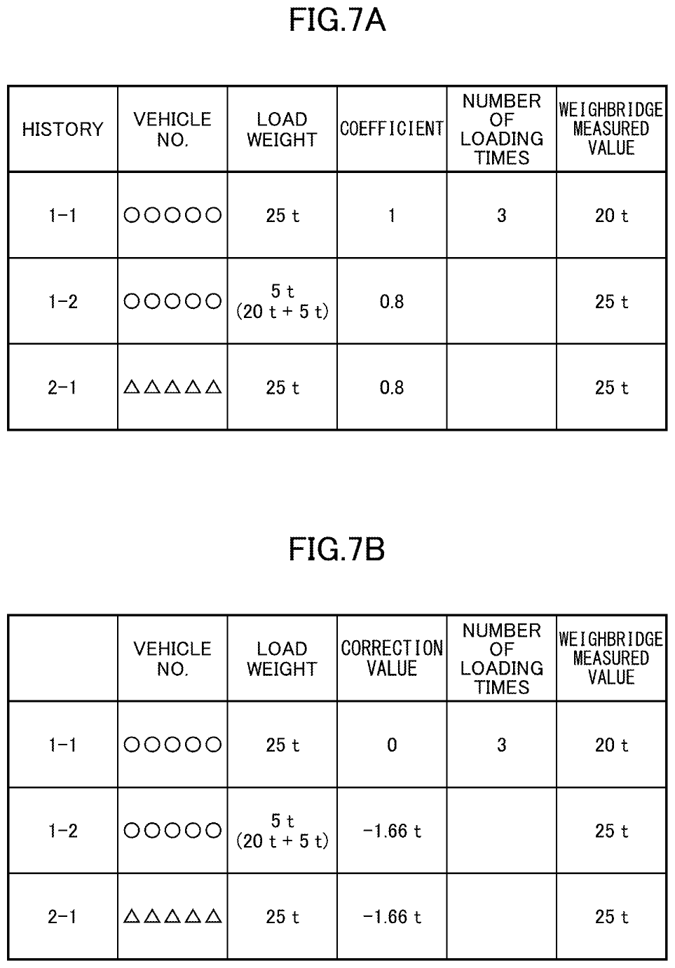

As illustrated in FIGS. 7A and 7B, which will be described later, the carried-material weight processing part 60 records vehicle identification information (e.g., vehicle No.) for identifying the dump truck DT, the load weight of the carried material loaded on the dump truck DT calculated by the load weight calculation part 76, the correction value (the correction coefficient α or the offset value β) used by the weight conversion part 75, and the number of loading times in the storage device 47 as a history.

The weighbridge weight input part 77 inputs the load weight (the weighbridge measured value) measured by the weighbridge device 550. For example, the weighbridge device 550 and the controller 30 of the shovel 100 may be communicatively connected, and the load weight (the weighbridge measured value) measured by the weighbridge device 550 may be transmitted (input) to the controller 30. In this case, the dump truck DT to be measured in the weighbridge device 550 is associated with the dump truck DT to be loaded with the carried material by the shovel 100, and the shovel 100 sets a correction value. An imaging device for identifying the dump truck DT to be measured may be disposed in the weighbridge device 550. Based on the license plate of the dump truck DT detected by the imaging device of the weighbridge device 550 and the license plate of the dump truck DT detected by the spatial recognition device of the shovel 100, the shovel 100 can associate the dump truck DT to be measured with the dump truck DT to be loaded with the carried material by the shovel 100. In addition, the shovel 100 may associate the dump truck DT to be measured with the dump truck DT to be loaded with the carried material by the shovel 100 according to the history of GNSS installed in the dump truck DT. Furthermore, the shovel 100 may utilize the GNSS of the mobile terminal possessed by the driver of the dump truck DT. The load weight (the weighbridge measured value) measured by the weighbridge device 550 may be transmitted to the shovel 100 via a management device (not illustrated) at the yard 500. Also, the operator of the dump truck DT, a manager in the yard 500, or the like communicates the load weight measured by the weighbridge device 550 (the weighbridge measured value) to the operator of the shovel 100. Then, the load weight measured by the weighbridge device 550 (the weighbridge measured value) may be input to the controller 30 (the weighbridge weight input part 77) by the operator of the shovel 100 operating the input device 42.

The correction value generation part 78 generates a correction value, based on the history recorded by the carried-material weight processing part 60 and the load weight (the weighbridge measured value) input by the weighbridge weight input part 77. The generated correction value is input to the weight conversion part 75.

FIGS. 7A and 7B are tables illustrating examples of histories recorded in the storage device 47 of the shovel 100. The following description illustrates a case where the maximum load of the dump truck DT is 25 t.

### <Example of Correcting the Weight of the Carried Material Using the Correction Coefficient α>

First, a case where the weight W₁ of the carried material calculated by the weight conversion part 75 is corrected using the correction coefficient α to calculate the weight W of the carried material will be described with reference to FIG. 7A.

First, the shovel 100 performs the first loading operation on a first dump truck DT. Here, the shovel 100 loads the maximum load of the carried material on the loading bed of the dump truck DT, identified by the vehicle No. OOOOO.

In this case, the weight W of the carried material is calculated by the weight conversion part 75 with the correction coefficient α=1. Then, the loading operation is repeated until the load weight of the carried material calculated by the load weight calculation part 76 becomes 25 t. The following description will be given based on the assumption that the number of loading times required to load 25 t of the carried material be 3 times.

When the load weight calculated by the load weight calculation part 76 becomes 25 t, the loading operation is finished. The carried-material weight processing part 60 records the vehicle identification information “VEHICLE NO. OOOOO”, the load weight “25 t”, the correction coefficient α “1”, and the number of loading times “3” in the storage device 47 as a history 1-1.

The dump truck DT moves from the loading position 540 to the weighbridge device 550, and measures the load weight (the weighbridge measured value) of the carried material loaded on the dump truck DT. The following description is given on the assumption that the weighbridge measured value measured by the weighbridge device 550 be 20 t. In this case, the dump truck DT returns to the loading position 540 again.

The weighbridge measured value “20 t” is input to the weighbridge weight input part 77. The carried-material weight processing part 60 records the weighbridge measured value “20 t” input by the weighbridge weight input part 77 in association with the history 1-1.

A correction value generation part 78 generates a correction coefficient α based on the history. More specifically, the correction coefficient α is generated, based on a ratio of the weighbridge measured value input by the weighbridge weight input part 77 to the load weight calculated by the load weight calculation part 76 (the weighbridge measured value/the load weight). For example, the correction coefficient α is calculated as “0.8” (=20/25) from the weighbridge measured value “20 t” and the load weight “25 t” in the history 1-1. The correction coefficient α is then input to the weight conversion part 75.

Next, the shovel 100 performs a second loading operation on the first dump truck DT. In this case, the shovel 100 loads the insufficient amount of the carried material on the loading bed of the dump truck DT with the vehicle No. OOOOO. Here, the difference between the maximum load of 25 t and the weighbridge measured value of 20 t is 5 t. As a result, the shovel 100 loads the maximum load (20 t already loaded+5 t for the insufficient amount) of the carried material on the loading bed of the dump truck DT, identified by vehicle No. OOOOO.

In this case, the weight W of the carried material is calculated by the weight conversion part 75 with the correction coefficient α=0.8. Then, the loading operation is repeated until the load weight of the carried material calculated by the load weight calculation part 76 becomes 5 t (in other words, until the load weight of the carried material including the loaded 20 t is 25 t).

When the load weight calculated by the load weight calculation part 76 becomes 5 t (in other words, when the load weight of the carried material including the loaded 20 t is 25 t), the loading operation is finished. The carried-material weight processing part 60 records the vehicle identification information “VEHICLE NO. OOOOO”, the load weight “5 t”, the correction coefficient α “0.8”, and the number of loading times in the storage device 47 as a history 1-2.

The dump truck DT moves from the loading position 540 to the weighbridge device 550, and measures the load weight (the weighbridge measured value) of the loaded material loaded on the dump truck DT. Since the weight W of the loaded material calculated by the weight conversion part 75 is corrected by the correction coefficient α, the weight conversion part 75 can accurately calculate the weight W of the loaded material. In addition, the load weight calculation part 76 can accurately calculate the load weight of the dump truck DT. As a result, the weighbridge measured value measured by the weighbridge device 550 can be close to the maximum load. In the following, the weighbridge measured value measured by the weighbridge device 550 is assumed to be 25 t. The weighbridge weight input part 77 receives the load weight “25 t”. The carried-material weight processing part 60 records the weighbridge measured value “25 t” measured received by the weighbridge weight input part 77 in association with the history 1-2.

Next, the shovel 100 performs a first loading operation on a second dump truck DT. In this case, the shovel 100 loads the maximum load of the carried material onto the loading bed of the dump truck DT, identified by the vehicle No. ΔΔΔΔΔ. Here, the weight W of the carried material is calculated by the weight conversion part 75 with the correction coefficient α=0.8. The loading operation is repeated until the load weight of the carried material calculated by the load weight calculation part 76 becomes 25 t.

When the load weight calculated by the load weight calculation part 76 becomes 25 t, the loading operation is finished. The carried-material weight processing part 60 records the vehicle identification information “VEHICLE NO. ΔΔΔΔΔ”, the load weight “25 t”, the correction coefficient α “0.8”, and the number of loading times in the storage device 47 as a history 2-1.

The second dump truck DT moves from the loading position 540 to the weighbridge device 550, and measures the load weight (the weighbridge measured value) of the carried material loaded on the dump truck DT. Since the weight W of the carried material calculated by the weight conversion part 75 is corrected by the correction coefficient α, the weight conversion part 75 can accurately calculate the weight W of the carried material. In addition, the load weight calculation part 76 can accurately calculate the load weight of the dump truck DT. As a result, the weighbridge measured value measured by the weighbridge device 550 can be close to the maximum load. Here, a description is given on the assumption that the weighbridge measured value measured by the weighbridge device 550 be 25 t. The weighbridge measured value “25 t” is input to the weighbridge weight input part 77. The weight processing part 60 records the weighbridge measured value “25 t” input by the weighbridge weight input part 77 in association with the history 2-1.

Thus, in the shovel 100 according to the present embodiment, the weight W of the carried material calculated by the weight conversion part 75 can be corrected by the correction coefficient α, so that the weight W of the carried material can be accurately calculated. In addition, the load weight calculation part 76 can accurately calculate the load weight of the dump truck DT. As a result, the number of times that the dump truck DT returns to the loading position 540 from the weighbridge device 550 can be reduced. In addition, the dump truck DT can contribute to the improvement of transportation efficiency and the prevention of overloading.

### <Example of Correcting the Weight of the Carried Material Using the Offset Value β>

Next, a case where the weight W₁ of the carried material calculated by the weight conversion part 75 is corrected using the offset value @ to calculate the weight W of the carried material will be described with reference to FIG. 7B.

First, the shovel 100 performs a first loading operation on the first dump truck DT. In this case, the shovel 100 loads the maximum load of carried material onto the loading bed of the dump truck DT, identified by vehicle No. OOOOO.

Here, the weight W of the carried material is calculated by the weight conversion part 75 with the offset value β=0. Then, the loading operation is repeated until the load weight of the carried material calculated by the load weight calculation part 76 becomes 25 t. The following description is illustrated based on the assumption that the number of loading times required to load 25 t of the carried material be 3 times.

When the load weight calculated by the load weight calculation part 76 becomes 25 t, the loading operation is terminated. The carried-material weight processing part 60 records the vehicle identification information “VEHICLE NO. OOOOO”, the load weight “25 t”, the offset value @ “0”, and the number of loading times “3” in the storage device 47 as the history 1-1.

The dump truck DT moves from the loading position 540 to the weighbridge device 550, and measures the load weight (weighbridge measured value) of the carried material loaded on the dump truck DT. Here, a description is given on the assumption that the weighbridge measured value measured by the weighbridge device 550 be 20 t. In this case, the dump truck DT returns to the loading position 540 again.

The weighbridge measured value “20 t” is input to the weighbridge weight input part 77. The carried-material weight processing part 60 records the weighbridge measured value “20 t” input by the weighbridge weight input part 77 in association with the history 1-1.

The correction value generation part 78 generates an offset value β, based on the history. Specifically, the offset value β is generated, based on a value obtained by dividing a difference between the weighbridge measured value inputted by the weighbridge weight input part 77 and the load weight calculated by the load weight calculation part 76 by the number of loading times ((the weighbridge measured value−the load weight)/the number of loading times). For example, the offset value β is calculated as “−1.66 t” (=(20−25)/3) from the weighbridge measured value “20 t”, the load weight “25 t”, and the number of loading times “3” in the history 1-1. The offset value β is then input to the weight conversion part 75.

Next, the shovel 100 performs a second loading operation on the first dump truck DT. In this case, the shovel 100 loads the insufficient amount of the carried material on the loading bed of the dump truck DT with the vehicle No. OOOOO. Here, the difference between the maximum load of 25 t and the weighbridge measured value of 20 t is 5 t. As a result, the shovel 100 loads the maximum load (20 t already loaded+5 t for the insufficient amount) of the carried material on the loading bed of the dump truck DT, identified by the vehicle No. OOOOO.

Here, the weight W of the carried material is calculated by the weight conversion part 75 with the offset value β being set to −1.66 t. Then, the loading operation is repeated until the load weight of the carried material calculated by the load weight calculation part 76 becomes 5 t (in other words, until the load weight of the carried material including the loaded 20 t is 25 t).

When the load weight calculated by the load weight calculation part 76 becomes 5 t (in other words, when the load weight of the carried material including the loaded 20 t is 25 t), the loading operation is finished. The carried-material weight processing part 60 records the vehicle identification information “VEHICLE NO. OOOOO”, the load weight “5 t”, the offset value β “−1.66 t”, and the number of loading times in the storage device 47 as the history 1-2.

The dump truck DT moves from the loading position 540 to the weighbridge device 550, and measures the load weight (the weighbridge measured value) of the carried material loaded on the dump truck DT. Since the weight W of the carried material calculated by the weight conversion part 75 is corrected by the offset value β, the weight conversion part 75 can accurately calculate the weight W of the carried material. The load weight calculation part 76 can accurately calculate the load weight of the dump truck DT. As a result, the weighbridge measured value measured by the weighbridge device 550 may be made close to the maximum load. Here, a description is given on the assumption that the weighbridge measured value measured by the weighbridge device 550 be 25 t. The weighbridge measured value “25 t” is input to the weighbridge weight input part 77. The carried-material weight processing part 60 records the weighbridge measured value “25 t” input to the weighbridge weight input part 77 in association with the history 1-2.

Next, the shovel 100 performs the first loading operation on the second dump truck DT. In this case, the shovel 100 loads the maximum load of the carried material on the loading bed of the dump truck DT, identified by the vehicle No. ΔΔΔΔΔ. Here, the weight W of the carried material is calculated by the weight conversion part 75 with the offset value β. Then, the loading operation is repeated until the load weight of the carried material calculated by the load weight calculation part 76 becomes 25 t.

When the load weight calculated by the load weight calculation part 76 becomes 25 t, the loading operation is finished. The carried-material weight processing part 60 records the vehicle identification information “VEHICLE NO. ΔΔΔΔΔ”, the load weight “25 t”, the offset value β “−1.66 t”, and the number of loading times in the storage device 47 as a history 2-1.

The second dump truck DT moves from the loading position 540 to the weighbridge device 550, and measures the load weight (the weighbridge measured value) of the carried material loaded on the dump truck DT. Since the weight W of the carried material calculated by the weight conversion part 75 is corrected by the offset value β, the weight conversion part 75 can accurately calculate the weight W of the carried material. Also, the load weight calculation part 76 can accurately calculate the load weight of the dump truck DT. As a result, the weighbridge measured value measured by the weighbridge device 550 can be close to the maximum load. Here, a description is given on the assumption that the weighbridge measured value measured by the weighbridge device 550 be 25 t. The weighbridge measured value “25 t” is input to the weighbridge weight input part 77. The carried-material weight processing part 60 records the weighbridge measured value “25 t” input to the weighbridge weight input part 77 in association with the history 2-1.

Thus, in the shovel 100 according to the present embodiment, the weight W of the carried material calculated by the weight conversion part 75 can be corrected by the offset value β, so that the weight W of the carried material can be accurately calculated. In addition, the load weight calculation part 76 can accurately calculate the load weight of the dump truck DT. As a result, the number of times that the dump truck DT returns to the loading position 540 from the weighbridge device 550 can be reduced. In addition, the dump truck DT can contribute to the improvement of transportation efficiency and the prevention of overloading.

The embodiments, and the like of the shovel 100 have been described above, but the present invention is not limited to the above embodiments, and the like, and various modifications and improvements can be made within the scope of the gist of the present invention described in the claims.

The carried-material weight processing part 60 (carried-material weight calculation part 61) has been described as being provided in the controller 30 of the shovel 100, as illustrated in FIGS. 3 and 5, but the invention is not limited to this configuration. For example, the carried-material weight processing part 60 (carried-material weight calculation part 61) may be provided in a management device (work machine support system) provided in the yard 500, or the like.

In this configuration, the shovel (work machine) 100 transmits detection values detected by various sensors to the management device through the communication device T1. The carried-material weight processing part 60 (carried-material weight calculation part 61) of the management device calculates the load weight of the carried material loaded on the vehicle based on the detection values of the various sensors. In addition, the management device has an input part configured to input the load weight of the carried material loaded on the dump truck DT (the weighbridge measured value). For example, the management device is communicatively connected to the weighbridge device 550 and transmits the load weight of the carried material loaded on the dump truck DT measured by the weighbridge device 550 (the weighbridge measured value). The other configurations are the same as those in the case where the controller 30 of the shovel 100 is provided with the carried-material weight processing part 60 (carried-material weight calculation part 61), and the duplicated descriptions are omitted.

According to the above-described embodiment, a work machine and a work machine support system that accurately calculate the weight of a carried material can be provided.

It should be understood that the invention is not limited to the above-described embodiment, but may be modified into various forms on the basis of the spirit of the invention. Additionally, the modifications are included in the scope of the invention.

### DESCRIPTION OF THE REFERENCE NUMERALS

60 carried-material weight processing part
61 carried-material weight calculation part
71 torque calculation part
72 inertial force calculation part
73 centrifugal force calculation part
74 stationary torque calculation part
75 weight conversion part
76 load weight calculation part
77 weighbridge weight input part
78 correction value generation part
100 shovel (work machine)
500 yard
510 collection site
520 work device
530 collection site
540 loading position
550 weighbridge device
DT dump truck

What is claimed is:

1. A work machine comprising:
processing circuitry, and a memory storing computer-readable instructions, which when executed by the processing circuitry, cause the work machine to perform a process including
calculating a load weight of a carried material loaded on a vehicle,
inputting a weighbridge measured value, and
generating a correction value, based on the weighbridge measured value inputted in the inputting and the load weight calculated in the calculating, wherein
the calculating includes correcting the load weight by the correction value to calculate a corrected load weight.

2. The work machine according to claim 1, wherein the weighbridge measured value received in the inputting is transmitted from a weighbridge device, the weighbridge device measuring a weight of the vehicle.

3. The work machine according to claim 1, wherein the weighbridge measured value received in the inputting is input by an operator.

4. The work machine according to claim 1, wherein the correction value in the generating is generated, based on a ratio of the weighbridge measured value to the load weight.

5. The work machine according to claim 1, wherein the correction value in the generating is generated, based on a value obtained by dividing a difference between the load weight and the weighbridge measured value by a number of loading times.

6. The work machine according to claim 1, wherein the weighbridge measured value is a weight of a carried material loaded on the vehicle, a weight of the vehicle being measured by the weighbridge device.

7. A work machine support system comprising:
processing circuitry, and a memory storing computer-readable instructions, which when executed by the processing circuitry, cause the work machine support system to perform a process including
calculating a load weight of a carried material loaded on a vehicle,
inputting a weighbridge measured value, and
generating a correction value, based on the weighbridge measured value input in the inputting and the load weight calculated in the calculating, wherein
the calculating includes correcting the load weight by the correction value to calculate a corrected load weight.

8. The work machine support system according to claim 7, wherein the weighbridge measured value received in the receiving is transmitted from a weighbridge device, the weighbridge device measuring a weight of the vehicle.

9. The work machine support system according to claim 7, wherein the weighbridge measured value is a weight of a carried material loaded on the vehicle, a weight of the vehicle being measured by the weighbridge device.
